(19) United States
(12) Patent Application Publication
(10) Pub. No.: US 2026/0336660 A1
(43) Pub. Date: Oct. 29, 2026

(54) SYSTEM AND METHOD FOR MANEUVERING AN AUTONOMOUS VEHICLE

(71) Applicant: GM Global Technology Operations LLC, Detroit, MI (US)

(72) Inventors: Paul G. Otanez, Franklin, MI (US); Richard Romano, Shelby Township, MI (US); Nikolai K. Moshchuk, Grosse Pointe Farms, MI (US); SeyedAlireza Kasaiezadeh Mahabadi, Waterloo (CA)

(73) Assignee: GM Global Technology Operations LLC, Detroit, MI (US)

(21) Appl. No.: 19/192,568

(22) Filed: Apr. 29, 2025

(51) Int. Cl. B60W 60/00

(52) U.S. Cl. CPC B60W 60/0013; B60W 2710/207; B60W 2720/14

(57) ABSTRACT

A method of operating an autonomous vehicle includes receiving a desired route for the autonomous vehicle that includes at least one curved segment. The method also includes determining a vehicle trajectory for the autonomous vehicle to follow based on the desired route by selecting a front steering path for a pair of front steering wheels and a rear steering path for a pair of rear steering wheels that minimizes a yaw rate of change within a predetermined frequency range along the vehicle trajectory. The method also includes directing the autonomous vehicle to follow the vehicle trajectory.

### BACKGROUND

The present disclosure relates to vehicle maneuvering, and more particularly, to a system and method for maneuvering an autonomous vehicle.

A number of factors can contribute to the comfort of occupants in a vehicle during a trip. One approach to improve occupant comfort is through suspension tuning to remove harshness from variations in the road surface. Additionally, roads with certain profiles, such as curvy roads, can lead occupants to experience motion due to the cyclic movement of the vehicle. In these situations, the driver of the vehicle may reduce the speed of the vehicle to improve occupant comfort or select a different route.

### SUMMARY

Disclosed herein is a method of operating an autonomous vehicle. The method includes receiving a desired route for the autonomous vehicle that includes at least one curved segment. The method also includes determining a vehicle trajectory for the autonomous vehicle to follow based on the desired route by selecting a front steering path for a pair of front steering wheels and a rear steering path for a pair of rear steering wheels that minimizes a yaw rate of change within a predetermined frequency range along the vehicle trajectory. The method also includes directing the autonomous vehicle to follow the vehicle trajectory.

In one aspect of the disclosure the predetermined frequency range is determined utilizing a multi order bandpass filter of a weighted formulation in a frequency domain based on frequency ranges corresponding to visual and inner ear disturbances.

In one aspect of the disclosure the predetermined frequency range determined from the weighted formulation in the frequency domain is incorporated into a weighted formulation in a time domain to determine a control for the vehicle trajectory.

In one aspect of the disclosure a control in the weighted formulation in the time domain is determined by minimizing the weighted formulation in the time domain as a cost function.

In one aspect of the disclosure the weighted formulation in the time domain includes a weighted matrix of predicted errors for a lateral error output and a weighted matrix for control actions.

In one aspect of the disclosure the weighted matrix for control actions includes a weight associated with a front steer input to a vehicle controller, a weight associated with a rear steer input to the vehicle controller, and a weight associated with a vehicle yaw moment input to the vehicle controller.

In one aspect of the disclosure the vehicle trajectory is at least partially based on a preselected driving mode for the autonomous vehicle.

In one aspect of the disclosure the preselected driving mode reduces a yaw rate of change for the autonomous vehicle below the predetermined frequency range.

In one aspect of the disclosure the preselected driving mode increases a yaw rate of change for the autonomous vehicle above the predetermined frequency range.

In one aspect of the disclosure the predetermined frequency range is greater than or equal to 1.0 Hz and less than or equal to 5.0 Hz.

Disclosed herein is a non-transitory computer-readable storage medium embodying programmed instructions which, when executed by a processor, are operable for performing a method of operating an autonomous vehicle. The method includes receiving a desired route for the autonomous vehicle that includes at least one curved segment. The method also includes determining a vehicle trajectory for the autonomous vehicle to follow based on the desired route by selecting a front steering path for a pair of front steering wheels and a rear steering path for a pair of rear steering wheels that minimizes a yaw rate of change within a predetermined frequency range along the vehicle trajectory. The method also includes directing the autonomous vehicle to follow the vehicle trajectory.

In one aspect of the disclosure the predetermined frequency range is determined utilizing a multi order bandpass filter of a weighted formulation in a frequency domain based on frequency ranges corresponding to visual and inner ear disturbances.

In one aspect of the disclosure the predetermined frequency range determined from the weighted formulation in the frequency domain is incorporated into a weighted formulation in a time domain to determine a control for the vehicle trajectory.

In one aspect of the disclosure a control in the weighted formulation in the time domain is determined by minimizing the weighted formulation in the time domain as a cost function.

In one aspect of the disclosure the weighted formulation in the time domain includes a weighted matrix of predicted errors for a lateral error output and a weighted matrix for control actions.

In one aspect of the disclosure the weighted matrix for control actions includes a weight associated with a front steer input to a vehicle controller, a weight associated with a rear steer input to the vehicle controller, and a weight associated with a vehicle yaw moment input to the vehicle controller.

Disclosed herein is an autonomous vehicle. The vehicle includes a body at least partially defining a passenger cabin, a front steering system configured to generate a front road wheel angle with a pair of front wheels, and a rear steering system configured to generate a rear road wheel angle with a pair of rear wheels. The vehicle also includes at least one driver lateral selection device located within the passenger cabin, a hand wheel located within the passenger cabin and in communication with a hand wheel position sensor, and a controller in electrical communication with the front steering system, the rear steering system, the at least one driver lateral selective device, and the hand wheel position sensor, the controller is configured to receive a desired route for the autonomous vehicle that includes at least one curved segment. The controller is also configured to determine a vehicle trajectory for the autonomous vehicle to follow based on the desired route by selecting a front steering path for a pair of front steering wheels and a rear steering path for a pair of rear steering wheels that minimizes a yaw rate of change within a predetermined frequency range along the vehicle trajectory. The controller is also configured to direct the autonomous vehicle to follow the vehicle trajectory.

### BRIEF DESCRIPTION OF THE DRAWINGS

The accompanying drawings, which are incorporated into and constitute a part of this specification, illustrate implementations of the disclosure and together with the description, explain the principles of the disclosure.

FIG. 1 schematically illustrates an example vehicle having a front steering system and a rear steering system.

FIG. 2 illustrates an example method of operating the vehicle of FIG. 1.

FIG. 3 illustrates a graphical representation in a frequency domain.

FIG. 4 illustrates an example vehicle trajectory for the vehicle of FIG. 1.

FIG. 5 illustrates another example vehicle trajectory for the vehicle of FIG. 1.

### DETAILED DESCRIPTION

The present disclosure is susceptible of embodiments in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof. As used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

Embodiments of the present disclosure may be described herein in terms of functional and/or logical block components and various processing steps. It should be appreciated that such block components may be realized by a number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with a number of systems, and that the systems described herein are merely exemplary embodiments of the present disclosure.

For the sake of brevity, techniques related to signal processing, data fusion, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that alternative or additional functional relationships or physical connections may be present in an embodiment of the present disclosure.

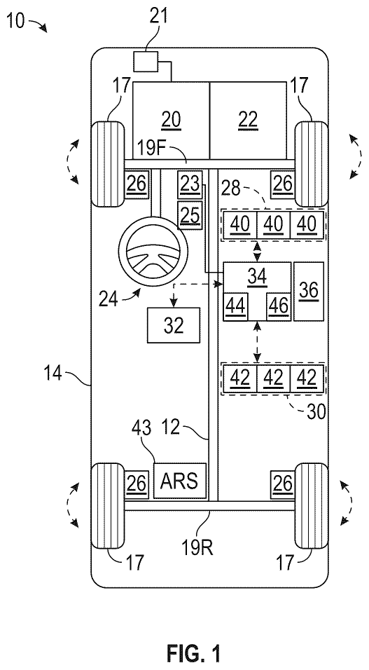

With reference to FIG. 1, the vehicle 10 generally includes a chassis 12, a body 14, front and rear wheels 17. The body 14 is arranged on the chassis 12 and substantially encloses components of the vehicle 10 and defines a passenger cabin. The body 14 and the chassis 12 may jointly form a frame. The wheels 17 are each rotationally coupled to the chassis 12 near a respective corner of the body 14. The vehicle wheels 17 are supported by a front axle 19F and a rear axle 19R. In various embodiments, the vehicle 10 may be an autonomous vehicle. The vehicle 10 is, for example, a vehicle that is automatically controlled to carry passengers from one location to another.

As shown, the vehicle 10 generally includes a propulsion system 20, a transmission system 22, a steering system 24, a brake system 26, a sensor system 28, an actuator system 30, at least one driver lateral selection device 32, at least one controller 34, and a communication system 36. The propulsion system 20 may, in various embodiments, include an electric machine such as a one or more traction motor to enable torque vectoring, and/or a fuel cell propulsion system. The vehicle 10 further includes a battery (or battery pack) 21 electrically connected to the propulsion system 20. Accordingly, the battery pack 21 is configured to store electrical energy and to provide electrical energy to the propulsion system 20. Additionally, the propulsion system 20 may include an internal combustion engine. The transmission system 22 is configured to transmit power from the propulsion system 20 to the vehicle wheels 17 according to selectable speed ratios. According to various embodiments, the transmission system 22 may include a step-ratio automatic transmission, a continuously variable transmission, or other appropriate transmission. The brake system 26 is configured to provide braking torque to the vehicle wheels 17. The brake system 26 may, in various embodiments, include friction brakes, brake by wire, a regenerative braking system such as an electric machine, and/or other appropriate braking systems. The steering system 24 influences a position of the vehicle wheels 17. While depicted as including a steering wheel for illustrative purposes, in some embodiments contemplated within the scope of the present disclosure, the steering system 24 may not include a steering wheel.

The sensor system 28 includes one or more sensors 40 (i.e., sensing devices) that sense observable conditions of the exterior environment and/or the interior environment of the vehicle 10. The sensors 40 are in communication with the controller 34 and may include, but are not limited to, one or more radars, one or more light detection and ranging (lidar) sensors, one or more ground penetrating radar (GPR) sensors, one or more global positioning systems (GPS) devices, one or more cameras (e.g., optical cameras and/or thermal cameras, such as a rear camera and/or a front camera), brake pedal position sensor, accelerator pedal position sensor, steering angle sensor, speed sensor, wheel speed sensor, ride height sensors, steering angle sensor, ultrasonic sensors, one or more inertial measurement units (IMUs), and/or other sensors.

The actuator system 30 includes one or more actuator devices 42 that control one or more vehicle features such as, but not limited to, the propulsion system 20, the transmission system 22, the steering system 24 including front and rear steering components, and the brake system 26. In this disclosure, the steering system 24 includes a front steering system 25 for turning the front wheels 17 and a rear steering system 43, such as an active rear steer (ARS) system, for steering the rear wheels 17 independently of the front wheels 17. Furthermore, the front steering system and the rear steering system are each drive-by-wire systems without a direct mechanical connection between the steering wheel and the wheels 17. In various embodiments, the vehicle features can further include interior and/or exterior vehicle features such as, but are not limited to, doors, a trunk, and cabin features such as air, music, lighting, etc. (not numbered). For example, the actuator devices 42 include an accelerator pedal, a brake pedal, etc.

The controller 34 includes at least one processor 44 and a non-transitory computer readable storage device or medium 46. The processor 44 can be a custom made or commercially available processor, a central processing unit (CPU), a graphics processing unit (GPU), an auxiliary processor among several processors associated with the controller 34, a semiconductor-based microprocessor (in the form of a microchip or chip set), a microprocessor, a combination thereof, or generally a device for executing instructions. The computer readable storage device or medium 46 may include volatile and nonvolatile storage in read-only memory (ROM), random-access memory (RAM), and keep-alive memory (KAM), for example. KAM is a persistent or nonvolatile memory that may be used to store various operating variables while the processor 44 is powered down. The computer-readable storage device or medium 46 may be implemented using a number of other memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the controller 34 in controlling the vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the vehicle 10, and generate control signals to the actuator system 30 to automatically control the components of the vehicle 10 based on the logic, calculations, methods, and/or algorithms. Although a single controller 34 is shown in FIG. 1, embodiments of the vehicle 10 may include a number of controllers 34 that communicate over a suitable communication medium or a combination of communication mediums and that cooperate to process the sensor signals, perform logic, calculations, methods, and/or algorithms, and generate control signals to automatically control features of the vehicle 10.

The vehicle 10 includes a human-machine interface (HMI) 23, which may be a center stack screen or a drive information center. The HMI 23 interacts with a user to show information and receives confirmation, activation, cancellation commands, etc. The HMI 23 may be configured as an alarm, such as a speaker to provide a sound, a haptic feedback in a vehicle seat or other object, a visual display, or other device suitable to provide a notification to the vehicle operator of the vehicle 10. The HMI 23 is in electronic communication with the controller 34 and is configured to receive inputs from a user (e.g., vehicle operator). Accordingly, the controller 34 is configured to receive inputs from the user via the HMI 23. The HMI 23 includes a display configured to display information to the user (e.g., vehicle operator or passenger) and may include one or more speakers to provide an auditable notification to the vehicle operator.

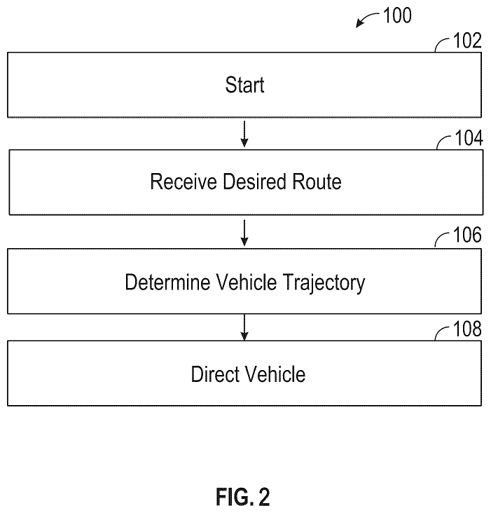

FIG. 2 illustrates a method 100 of operating the vehicle 10. The method 100 begins at block 102 (“Start”). From block 102, the method 100 proceeds to block 104. At block 104 (“Receive Desired Route”), the method 100 receives a desired route for the vehicle 10 to traverse. In one example, the desired route includes at least one curved segment. The curved segment can result from a curve in the road along the desired route or be the result of the vehicle 10 changing lanes along an otherwise straight road segment. Furthermore, the desired route can be determined from a route generating module on the controller 34 that forms a portion of the autonomous driving features of the vehicle 10. The route generating module can determine the desired route based on a data received from the sensor system 28. With the desired route, the method 100 proceeds to block 106.

At block 106 (“Determine Vehicle Trajectory”), the method 100 determines a vehicle trajectory for the vehicle 10 to follow based on the desired route received. One feature of this disclosure is to avoid operating the vehicle 10 in scenarios that can cause discomfort to the occupants of the vehicle 10. In particular, operating the vehicle 10 with a yaw rate of change within a predetermined frequency range can cause at least one of a visual disturbance or an inner ear disturbance to the occupants of the vehicle 10. In one example, this disclosure avoids or minimizes undesirable frequency ranges by formulating constraints in a frequency domain that are transformed back to a time domain to determine the vehicle trajectory. EQ. 1 below represents weighted formulation of a cost function (J) in a time domain that is minimized to determine a control u for selecting a front steering path and a rear steering path to satisfy the vehicle trajectory.

$$J = {\int }_{0}^{Δ T} \{ {[ y ϕ ]}_{err} \cdot Q ( t ) \cdot {[ \begin{matrix}y \\ ϕ\end{matrix} ]}_{err} + u \cdot R ( t ) \cdot {u}^{T} \} dt \to min \qquad EQ . 1$$

In EQ. 1 above, yₑᵣᵣ is a lateral offset error equal to y_{desired}−y_{predicted} and φₑᵣᵣ is a heading angle error equal to φ_{desired}−φ_{predicted}. Q(t) is a tuning parameter that includes a weighting matrix for predicted errors as shown in EQ. 2 below. Qₗₐₜₑᵣₐₗ is a weight associated with lateral error (output) and Q_{heading} is a weight associated with heading error (output).

$$Q = ( \begin{matrix}{Q}_{latera} & 0 \\ 0 & {Q}_{heading}\end{matrix} ) \qquad EQ . 2$$

R(t) is another tuning parameter that includes a weighting matrix for control actions as shown in EQ. 3 below. R_{front} is a weight associated with front steer (input to the controller 34), Rᵣₑₐᵣ is a weight associated with rear steer (input to the controller 34), and R_{RMz} is a weight associated with a vehicle yaw moment that is controlled by differential braking and/or torque vectoring (input to the controller 34).

$$R = ( \begin{matrix}{R}_{front} & 0 & 0 \\ 0 & {R}_{rear} & 0 \\ 0 & 0 & {R}_{db}\end{matrix} ) \qquad EQ . 3$$

Below, EQ. 4 defines a front steering angle δ_{f} and EQ. 5 defines a rear steering angle δᵣ for a scenario with zero lateral velocity. EQS. 4-5 include variables for a given curvature ρ at a velocity Vx, for a vehicle wheelbase L, having a front tire stiffness C_{f}, a rear tire stiffness Cᵣ, a distance a from a front axle to a center of gravity, a distance b from a rear axle to the center of gravity, and a moment of inertia I.

$${δ}_{f} = ρ ( a + \frac{{bMV}_{x}^{2}}{{C}_{f} L} ) + \dot{ρ} \frac{{IV}_{x}}{{C}_{f} L} \qquad EQ . 4$$

$${δ}_{r} = ρ ( - b + \frac{{aMV}_{x}^{2}}{{C}_{r} L} ) - \dot{ρ} \frac{{IV}_{x}}{{C}_{f} L} \qquad EQ . 5$$

Below, EQ. 6 defines a front steering angle δ_{f} and EQ. 7 defines a rear steering angle δᵣ for a scenario with zero yaw.

$${δ}_{f} = ρ \frac{{bMV}_{x}^{2}}{{C}_{f} L} + {V}_{x} \int ρ d τ \qquad EQ . 6$$

$${δ}_{γ} = ρ \frac{{aMV}_{x}^{2}}{{C}_{r} L} + {V}_{x} \int ρ d τ \qquad EQ . 7$$

Utilizing the above equations, J in EQ. 1 represents a cost of weighted deviation from the planned path plus the control u which is minimized as a cost function to find the control u.

EQ. 8 below represents the weighted formulation (J) converted to a frequency domain. In one example, a Faster Fourier Transform (FFT) is used to convert the weighted formulation (J) from the time domain (t) to the frequency domain (ω) to aid in targeting frequency ranges to avoid visual and inner ear disturbances.

$$J = {\int }_{- ∞}^{+ ∞} \{ \begin{matrix}{[ y ( ω ) ϕ ( ω ) ]}_{err} \cdot Q ( ω ) \cdot Q ( ω ) \cdot {[ \begin{matrix}y ( ω ) \\ ϕ ( ω )\end{matrix} ]}_{err} \\ + u ( ω ) \cdot R ( t ) \cdot {u ( ω )}^{T}\end{matrix} \} d ω \qquad EQ . 8$$

In EQ. 8 above, \hat{Q}(ω) is represented in a matrix in EQ. 9 below with qᵢ(ω) provided in EQ. 10 below.

$$\hat{Q} ( ω ) = [ \begin{matrix}{q}_{i} ( ω ) & 0 & 0 \\ 0 & ⋱ & 0 \\ 0 & 0 & {q}_{m} ( ω )\end{matrix} ] \qquad EQ . 9$$

$${q}_{i} ( ω ) = \frac{{α}_{i} + {β}_{i} j ω}{{γ}_{i} + {δ}_{i} j ω} \qquad EQ . 10$$

The desired parameters determine the transfer function(s) to shape the cost in EQ. 8. of EQ. 10 shape the transfer function(s). The alpha, beta, gamma, and delta in EQ. 10 are general tuning parameters for each qᵢ, j is an imaginary unit of a complex number, and omega is a course frequency. An example instance of the expression in EQ. 10 is shown in EQ. 11.

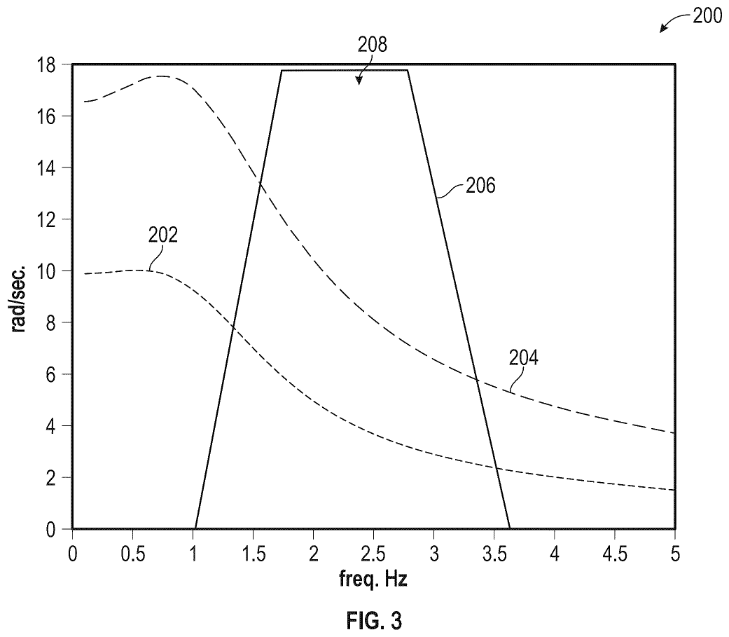

With EQS. 8-10, a graphical representation 200 that includes Hz along the x-axis and yaw rate in radians per second along the y-axis as shown in FIG. 3. The graphical representation 200 includes a line 202 that utilizes just the front steering and a line 204 that utilizes a combination of front and rear steering. A second order bandpass filter is represented with line 206 utilizing EQ. 11 below.

$${q}_{i} ( s ) = \frac{{c}_{1} s}{{c}_{2} {s}^{2} + {c}_{3} s + {c}_{4}} \qquad EQ . 11$$

In the illustrated example, the line 206 at least partially defines a region 208 of operation to avoid visual disturbance or an inner ear disturbance to the occupants of the vehicle 10. These parameters are based on EQS. 8-11 can then be translated into the time domain to utilize EQ. 1 to find the control u that contributes to determining the desired vehicle trajectory. While EQ. 11 illustrates a second order bandpass filter, higher order expressions can be used. With the desired vehicle trajectory determined, the method 100 can proceed to block 108.

Furthermore, the vehicle trajectory can be at least partially based on a preselected driving mode for the vehicle 10. For example, the preselected driving mode can reduce a yaw rate of change for the vehicle 10 below the predetermined frequency range or the preselected driving mode can increase a yaw rate of change for the vehicle 10 above the predetermined frequency range.

At block 108 (“Direct Vehicle”), the vehicle 10 is directed autonomously to follow the vehicle trajectory. In one example, the controller 34 sends control signals to the actuator system 30 on the vehicle 10 to follow the vehicle trajectory.

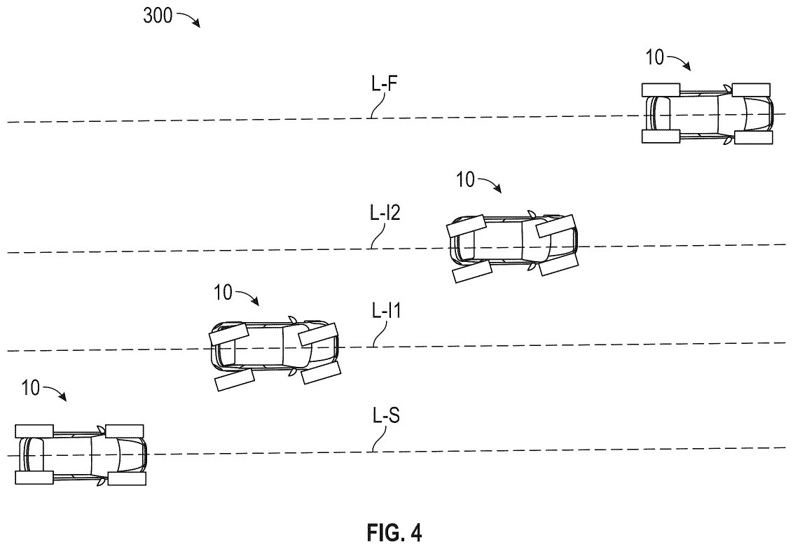

In one example, the vehicle can have approximately zero yaw rate with a lateral velocity (V_{y}) as shown in the example vehicle trajectory 300 of FIG. 4. In the example vehicle trajectory 300, the controller 34 on the vehicle 10 instructs the actuator system 30 to move from a starting lateral position L-S and moves through intermediate lateral positions L-I1 and L-I2 before reaching a final lateral position L-F. To accomplish this lateral movement, the front and rear wheels 17 follow a front steering path and a rear steering path, respectively, that begin straight at the starting lateral position L-S and include a maximum front and rear road wheel angle in a first rotational direction at one of the intermediate lateral positions L-I1 or L-I2 before returning to be straight at the final lateral position L-F.

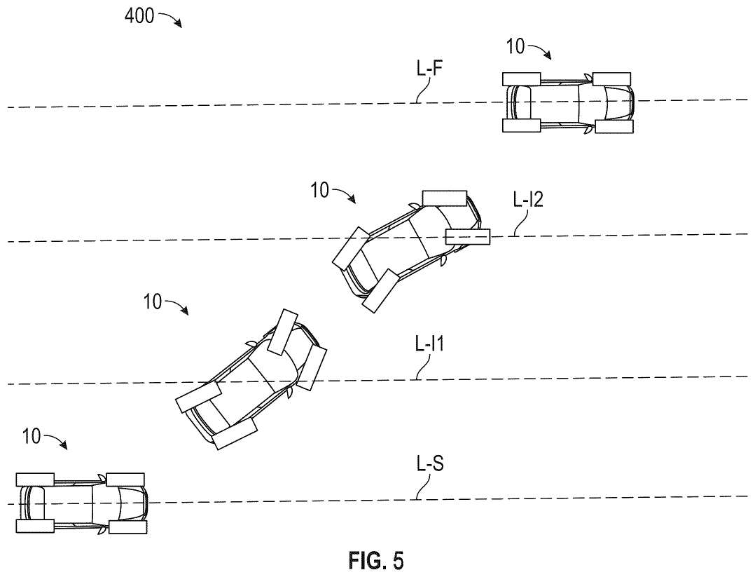

FIG. 5 illustrates another example vehicle trajectory 400. In the example vehicle trajectory 400, the controller 34 on the vehicle 10 instructs the actuator system 30 to move from a starting lateral position L-S and through intermediate lateral positions L-I1 and L-I2 before reaching a final lateral position L-F. To accomplish this lateral movement, the front and rear wheels follow front and rear wheel paths, respectively, that begin straight at the starting lateral positions L-S and include a first maximum front and rear road wheel angle in a first rotational direction at the first intermediate lateral positions L-I1. The front and rear wheels also include a second maximum front and rear road wheel angle in a second rotational direction at the second intermediate lateral position L-I2 before returning to be straight at the final lateral position L-F.

The terms “a” and “an” do not denote a limitation of quantity, but rather denote the presence of at least one of the referenced items. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in a suitable manner in the various aspects.

While the above disclosure has been described with reference to exemplary embodiments, it will be understood by those skilled in the art that various changes may be made, and equivalents may be substituted for elements thereof without departing from its scope. In addition, many modifications may be made to adapt a particular situation or material to the teachings of the disclosure without departing from the scope thereof. Therefore, it is intended that the present disclosure is not limited to the particular embodiments disclosed but will include embodiments falling within the scope thereof.

What is claimed is:

1. A method of operating an autonomous vehicle, the method comprising:
receiving a desired route for the autonomous vehicle, wherein the desired route includes at least one curved segment;
determining a vehicle trajectory for the autonomous vehicle to follow based on the desired route by selecting a front steering path for a pair of front steering wheels and a rear steering path for a pair of rear steering wheels that minimizes a yaw rate of change within a predetermined frequency range along the vehicle trajectory; and
directing the autonomous vehicle to follow the vehicle trajectory.

2. The method of claim 1, wherein the predetermined frequency range is determined utilizing a multi order bandpass filter of a weighted formulation in a frequency domain based on frequency ranges corresponding to visual and inner ear disturbances.

3. The method of claim 2, wherein the predetermined frequency range determined from the weighted formulation in the frequency domain is incorporated into a weighted formulation in a time domain to determine a control for the vehicle trajectory.

4. The method of claim 3, wherein a control in the weighted formulation in the time domain is determined by minimizing the weighted formulation in the time domain as a cost function.

5. The method of claim 4, wherein the weighted formulation in the time domain includes a weighted matrix of predicted errors for a lateral error output and a weighted matrix for control actions.

6. The method of claim 5, wherein the weighted matrix for control actions includes a weight associated with a front steer input to a vehicle controller, a weight associated with a rear steer input to the vehicle controller, and a weight associated with a vehicle yaw moment input to the vehicle controller.

7. The method of claim 1, wherein the vehicle trajectory is at least partially based on a preselected driving mode for the autonomous vehicle.

8. The method of claim 7, wherein the preselected driving mode reduces a yaw rate of change for the autonomous vehicle below the predetermined frequency range.

9. The method of claim 7, wherein the preselected driving mode increases a yaw rate of change for the autonomous vehicle above the predetermined frequency range.

10. The method of claim 1, wherein the predetermined frequency range is greater than or equal to 1.0 Hz and less than or equal to 5.0 Hz.

11. A non-transitory computer-readable storage medium embodying programmed instructions which, when executed by a processor, are operable for performing a method comprising:
receiving a desired route for an autonomous vehicle, wherein the desired route includes at least one curved segment;
determining a vehicle trajectory for the autonomous vehicle to follow based on the desired route by selecting a front steering path for a pair of front steering wheels and a rear steering path for a pair of rear steering wheels that minimizes a yaw rate of change within a predetermined frequency range along the vehicle trajectory; and
directing the autonomous vehicle to follow the vehicle trajectory.

12. The non-transitory computer-readable storage medium of claim 11, wherein the predetermined frequency range is determined utilizing a multi order bandpass filter of a weighted formulation in a frequency domain based on frequency ranges corresponding to visual and inner ear disturbances.

13. The non-transitory computer-readable storage medium of claim 12, wherein the predetermined frequency range determined from the weighted formulation in the frequency domain is incorporated into a weighted formulation in a time domain to determine a control for the vehicle trajectory.

14. The non-transitory computer-readable storage medium of claim 13, wherein a control in the weighted formulation in the time domain is determined by minimizing the weighted formulation in the time domain as a cost function.

15. The non-transitory computer-readable storage medium of claim 14, wherein the weighted formulation in the time domain includes a weighted matrix of predicted errors for a lateral error output and a weighted matrix for control actions.

16. The non-transitory computer-readable storage medium of claim 15, wherein the weighted matrix for control actions includes a weight associated with a front steer input to a vehicle controller, a weight associated with a rear steer input to the vehicle controller, and a weight associated with a vehicle yaw moment input to the vehicle controller.

17. An autonomous vehicle, comprising:
a body at least partially defining a passenger cabin;
a front steering system configured to generate a front road wheel angle with a pair of front wheels;
a rear steering system configured to generate a rear road wheel angle with a pair of rear wheels;
at least one driver lateral selection device located within the passenger cabin;
a hand wheel located within the passenger cabin and in communication with a hand wheel position sensor; and
a controller in electrical communication with the front steering system, the rear steering system, the at least one driver lateral selective device, and the hand wheel position sensor, the controller configured to:
receive a desired route for the autonomous vehicle, wherein the desired route includes at least one curved segment;
determining a vehicle trajectory for the autonomous vehicle to follow based on the desired route by selecting a front steering path for a pair of front steering wheels and a rear steering path for a pair of rear steering wheels that minimizes a yaw rate of change within a predetermined frequency range along the vehicle trajectory; and
direct the autonomous vehicle to follow the vehicle trajectory.

18. The autonomous vehicle of claim 17, wherein the predetermined frequency range is determined utilizing a multi order bandpass filter of a weighted formulation in a frequency domain based on frequency ranges corresponding to visual and inner ear disturbances.

19. The autonomous vehicle of claim 18, wherein the predetermined frequency range determined from the weighted formulation in the frequency domain is incorporated into a weighted formulation in a time domain to determine a control for the vehicle trajectory.

20. The autonomous vehicle of claim 19, wherein a control in the weighted formulation in the time domain is determined by minimizing the weighted formulation in the time domain as a cost function.
